(19) United States
(12) Patent Application Publication
(10) Pub. No.: US 2012/0273495 A1
(43) Pub. Date: Nov. 1, 2012

(54) Animal Deterrent Trash System

(76) Inventor: Lorraine D'Alessandro, St. James, NY (US)

(21) Appl. No.: 13/456,373

(22) Filed: Apr. 26, 2012

Related U.S. Application Data
(60) Provisional application No. 61/517,908, filed on Apr. 27, 2011.

(51) Int. Cl. B65D 45/16; B65F 1/14; B65D 45/00

(52) U.S. Cl. 220/326; 220/324

(57) ABSTRACT

An animal resistant trash system having a longitudinal hollow body having a closed end, and an open end; wherein the open end has of portion having a hinge for receiving a cover, the body having a post substantially perpendicular to its external surface extending. radially outwardly therefrom, wherein the post has a lip about the apex thereof; a cover that is hingedly connected to the body; and means for releasably securing the cover to the body.

### CROSS REFERENCE TO RELATED APPLICATIONS

This application claims priority from U.S. Provisional Patent Application No. having Ser. No. 61/517,908 having a filing date of 27 Apr. 2011.

### BACKGROUND OF THE INVENTION

This invention relates to a trash system, in particular, an animal deterrent trash system that provides, inter alia, a system to deter animals from accessing trash receptacles and thereby reducing the likelihood of animals raiding the trash receptacles and scattering the trash outside of the receptacle.

Historically, for homeowners and businesses that have experienced critters accessing their trash receptacles, the critters either pop off the top of the receptacle if not hingedly connected, or flip open the lids, thereby enabling access to the prized source of food therein. Other times, the critters will knock over the receptacle which sometimes causes the lid to pop off on impact with the ground, or enables the critter to maximize leverage in prying the lid from the receptacle. Regardless, of the method, the animals' activities often result in the trash being scattered all over the ground with undesirable results to the homeowner and/or business owner. Common approaches include storing the receptacle inside the garage or storage facility, however, in warmer climates, this can cause a putrid stench emanating into the home/business. Other approaches include incorporating locking, handles of the receptacle into a groove on the lid, but this is very easily overcome by the critters, and usually only results in preventing young children from accessing the receptacle, and often frustrates the homeowner. However, on collection day of the trash via sanitation department, the populated trash receptacles must be curbside by a certain hour of the early morning, wherein the typical homeowner/business owner puts the trash curbside in the early evening the night prior to pickup. Hence the method of storing the receptacle within a storage facility only works when it is not collected, but not on these evenings. The locking handles are insufficient to prevent the critters from knocking over the receptacle or merely, and quite often, unlocking the handle to access their dinner. Hence, there is a long standing need to provide. trash system that is animal resistant, and more preferably, animal proof.

### SUMMARY OF THE INVENTION

The present invention is directed to an animal resistant trash system.

An objective of the present invention is to improve reliability of performance, namely, deterrence of animals accessing trash receptacles.

A further objective of the present invention includes improved ergonometrics.

A still further objective of the present invention includes a unitary design.

An additional objective of the present invention includes ease of use.

Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 illustrates an isometric exploded view of the preferred embodiment;

FIG. 2 illustrates a close up elevational view of the post and means interface;

FIG. 3 illustrates an isometric view of the alternative preferred embodiment; and

FIG. 4 illustrates a close up elevational view of the post and means interface.

### DETAILED DESCRIPTION OF THE INVENTION

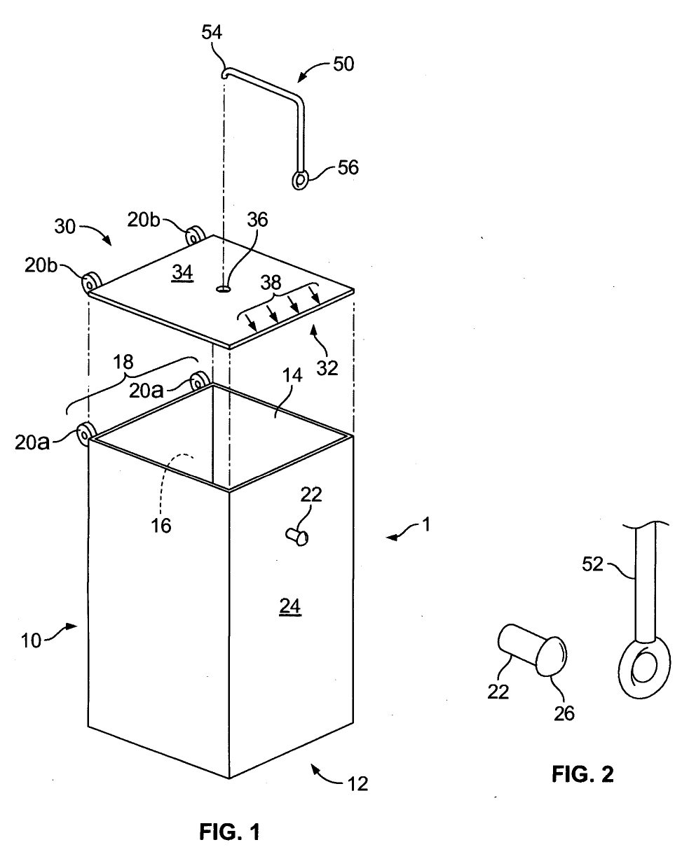

The following descriptions of the preferred embodiments are presented to illustrate the present invention and are not to be construed to limit the claims in any manner whatsoever. In reference to the drawings, namely FIGS. 1 to 2, the preferred embodiment of the present invention is disclosed, which is directed to an animal resistant trash system 1.

In a preferred embodiment, the system 1 has a body 10, a cover 30, and means 50 for releasably securing the cover 30 to the body 10. More specifically, the body 10 is a longitudinal hollow body 10 having a closed end 12, which functions as a base for the system 1 to stand upright. Although the body 10 has a volume in the range of about five (5) to about one hundred (100) gallons, it is envisioned that it 10 may be any volume. Nonetheless, the body 10 further has an open end 14 which provides access to the cavity 16 to store and remove stored contents therein 16, typically, trash. The open end 14 has a portion 18 having a hinge 20a for receiving a cover 30 to quarantine items stored in the cavity 16 and any undesirable fugitive emissions emanating therefrom.

The body 10 further includes at least one post 22 substantially perpendicular to its external surface 24, which extends radially outwardly from the outer surface 24 of the body 10. It is desirable that said post 22 has a lip 26 about the apex thereof, and be located most opposite to the hinged side 20, particularly if only one post 22 and cord 52 is used.

The system 1 further includes a cover 30 that is hingedly 20b connected to said body 10. The cover 30 substantially encloses the open end 14 of the body 10 so as to substantially seal in any trash and fugitive emissions in the closed state. In the open state, the cover 30 is flipped open about 270 degrees +/− so as to access the cavity 16 of the body 10 (not shown). The cover 30 further has an underside 32, and a topside 34, wherein the underside 32 is orientated towards the cavity 16 of the body 10 when the system 1 is in a closed state, and the topside 34 substantially outwardly therefrom.

The system 1 further includes means 50 for releasably securing said cover 30 to said body 10, wherein this means does not include the hinge 20. Specifically, the means 50 comprises at least one elastic cord 52, each having a first end 54 and a second 56 end, although a plurality of cords are envisioned. Wherein the first end 54 is affixed to the cover 10, and the second end 56 is configured and dimensioned to receive a post 22. In this embodiment, the cord 52 passes through an orifice 36 in the topside 34 of the cover 30 and is secured on the underside 32 of the cover 30, wherein the orifice 36 is preferably located equidistant between the hinge 20 and the opposite edge thereof 38, although it 36 may be located anywhere in-between.

In order to illustrate the device in use, the following is an example of deployment thereof. The homeowner stores the system 1 outside with the cover down in the closed state. In order to deposit a trash bag into the system 1, the homeowner would simply lift the cover upwardly by edge 38 with one hand, and deposit the bag of trash into the cavity 16 with the other hand. Once the trash bag is released, the cover 30 can be repositioned in the closed state, whereafter, the means 50 and the cord 52 can be grasped by the second end 56 and stretched such that the second end 56 reaches and grasps the lip portion 26 of the post 22. Once the second end 56 passes the lip 26 and is about the post 22, the homeowner can release means 50 and the system 1 is now deployed.

In order to use the system 1 and deposit, a second trash bag, or to access the deployed system 1, the homeowner need only reverse the procedure set forth hereinabove. Namely, grasp means 50 by end 56 and position the end 56 so that the end 56 navigates off of post 22 by bypassing around lip 26, and slowly permitting the means 50 to de-stretch back to its shortened relaxed state. Thereafter, the cover 30 can be lifted about the hinge 20 via edge 38 to access cavity 16 having the trash therein. Once the second bag of trash in inserted, and/or the operator empties the trash from the body 10, means 50 can be redeployed in harmony with the aforementioned instructions.

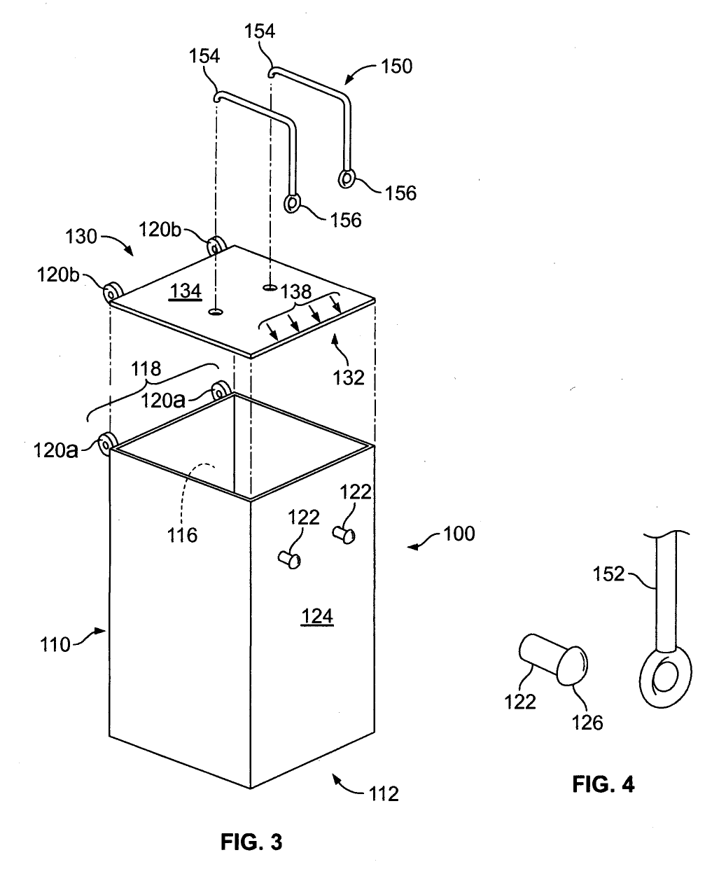

In reference to the drawings, namely FIGS. 3 to 4, the alternative preferred embodiment of the present invention is disclosed, which is directed to an animal resistant trash system 100.

In an alternative embodiment, the system 100 has a body 110, a cover 130, and means 150 for releasably securing the cover 130 to the body 110. More specifically, the body 110 is a longitudinal hollow body 110 having a closed end 112, which functions as a base for the system 100 to stand upright. Although the body 110 has a volume in the range of about five (5) to about one hundred (100) gallons, it is envisioned that it 110 may be any volume. Nonetheless, the body 110 further has an open end 114 which provides access to the cavity 116 to store and remove stored contents therein 116, typically, trash. The open end 114 has a portion 118 having a hinge 120a for receiving a cover 130 to quarantine items stored in the cavity 116 and any undesirable fugitive emissions emanating therefrom.

The body 110 further includes a plurality of posts 122 substantially perpendicular to its external surface 124, which extends radially outwardly from the outer surface 124 of the body 110. It is desirable that each post 122 has a lip 126 about the apex thereof, and be located most opposite to the hinged side 120, particularly only one post 122 and cord 152 is used.

The system 100 further includes a cover 130 that is hingedly 120b connected to said body 110. The cover 130 substantially encloses the open end 114 of the body 110 so as to substantially seal in any trash and fugitive emissions in the closed state. In the open state, the cover 130 is flipped open about 270 degrees +/− so as to access the cavity 116 of the body 110 (not shown). The cover 130 further has an underside 132, and a topside 134, wherein the underside 132 is orientated towards the cavity 116 of the body 110 when the system 100 is in a closed state, and the topside 134 substantially outwardly there from.

The system 100 further includes means 150 for releasably securing said cover 130 to said body 110, wherein this means does not include the hinge 120. Specifically, the means 150 comprises a plurality of elastic cords 152, each having a first end 154 and a second 156 end. Wherein the first end 154 is affixed to the cover 110, and the second end 156 is configured and dimensioned to receive a post 122. In this embodiment, the cord 152 passes through an orifice 136 in the topside 134 of the cover 130 and is secured on the underside 132 of the cover 130, wherein the orifice 136 is preferably located equidistant between, the hinge 120 and the opposite edge thereof 138, although it 136 may be located anywhere in-between.

It is further envisioned, in either of the embodiments, that the means 50,150 maybe be replaceable in the form of a kit. For example, various sized elastic cords 52,152 having various thicknesses and constants (similar measurement to a spring) which can be determined from Hooke's Law wherein F=−kx; and depending on the type of critters that the homeowner is attempting to prevent from accessing, yet still within the homeowner's strength to use the cord 52,152. Moreover, such kit may contain a plurality of cords 52,152 wherein should the cord 52,152 break, that the homeowner can easily replace the same. Lastly, in either embodiment, it is further envisioned that the post(s) 22,122 may be located on the top of the cover 34,134, and that the means 50,150 may be affixed to the surface 24,124.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application.

What is claimed is:

1. An animal resistant trash system comprising:
a longitudinal hollow body having a closed end, and an open end; wherein said open end has a portion having a hinge for receiving a cover, said body having a post substantially perpendicular to its external surface extending radially outwardly therefrom, wherein said post has a lip about the apex thereof;
a cover that is hingedly connected to said body; and
means for releasably securing said cover to said body.

2. A system of claim 1, wherein said body has a volume in the range of about five (5) to about one hundred (100) gallons.

3. A system of claim 1, wherein said means comprises an elastic cord, wherein the first end is affixed to said cover, and the second end is configured and dimensioned to receive said post.

4. A system of claim 1, wherein said second end further includes a looping means.

5. A system of claim 4, wherein said looping means comprises a plastic loop cooperatively connected to said second end.

6. An animal resistant trash system comprising:
a longitudinal hollow body having a closed end, and an open end wherein said open end has a portion having a hinge for receiving a cover, said body having a plurality of posts substantially perpendicular to its external surface extending radially outwardly therefrom, wherein each post has a lip about the apex thereof;
a cover that is hingedly connected to said body; and
means for releasably securing said cover to said body.

7. A system of claim 6, wherein said body has a volume in the range of about five (5) to about one hundred (100) gallons.

8. A system of claim 6, wherein said means comprises a plurality of elastic cords, wherein each first end is affixed to said cover, and each second end is configured and dimensioned to receive said post.

9. A system of claim 6, wherein said second end further includes a looping means.

10. A system of claim 6, wherein said looping means comprises a plastic loop cooperatively connected to said second end.
